(19) United States
(12) Patent Application Publication
(10) Pub. No.: US 2016/0263938 A1
(43) Pub. Date: Sep. 15, 2016

(54) BICYCLE RIM AND WHEEL

(71) Applicant: REYNOLDS CYCLING, LLC, Sandy, UT (US)

(72) Inventor: Paul E. Lew, Las Vegas, NV (US)

(21) Appl. No.: 15/067,102

(22) Filed: Mar. 10, 2016

Related U.S. Application Data
(60) Provisional application No. 62/131,967, filed on Mar. 12, 2015.

(51) Int. Cl. B60B 21/02; B60B 1/00; B60B 1/04

(52) U.S. Cl. CPC B60B 21/028; B60B 1/041; B60B 1/003; B60B 1/043; B60B 2310/242; B60B 2310/228; B60B 2360/3416; B60B 2900/1216

(57) ABSTRACT

A bicycle rim includes a rim body having an inner annular portion and an outer annular portion spaced radially outward from the inner annular portion. The inner annular portion has a circumference defined by a radially inward-most surface of the inner annular portion. A plurality of notches is spaced circumferentially along the circumference, the notches recessed within the inner annular portion to form a serrated edge along the circumference.

### CROSS-REFERENCE TO RELATED APPLICATION

This Application claims the benefit of U.S. Provisional Application No. 62/131,967, filed Mar. 12, 2015, titled “Aerodynamic Efficiency Improvement from Notching the Inside Diameter of a Bicycle Rim,” the entirety of which is incorporated herein by reference.

### BACKGROUND

Rim technology underlying the design of bicycle wheels has undergone many advances in recent years, leading to lightweight and sturdy rims that can be manufactured using a variety of materials and methods. The rims are generally used as components of assembled wheels which, individually, include a hub portion, a plurality of spokes and a rim, with the spokes connecting the hub to the rim. A tire is mounted on the rim, using either a clincher, tubular or tubeless configuration.

A recent focus in rim technology concerns aerodynamic efficiency. Aerodynamic efficiency may be achieved through shape design of the wheel and may lead to better control of the flow of air over the surface of the rim or, in many cases, the combination of the rim and tire, leading to reduced aerodynamic drag and increased ability of riders to achieve and maintain higher speeds. Shape designs leading to increased aerodynamic efficiencies are disclosed herein.

### BRIEF DESCRIPTION OF THE DRAWINGS

The accompanying drawings illustrate various examples of the principles described herein and are a part of the specification. The illustrated examples are merely examples and do not limit the scope of the claims.

FIGS. 1A and 1B are side and perspective views of a bicycle wheel having a notched rim in accordance with one example of the principles described herein;

FIGS. 2A and 2B are sectional and close-up views of a notched rim in accordance with one example of the principles described herein;

FIGS. 3A, 3B and 3C are close-up views of inner annular portions of rims, providing exemplar details of the structure of notches located along the inner circumference or radially inward-most surface of the rims;

FIGS. 4A and 4B are side and close-up views of a bicycle rim having notches in accordance with one example of the principles described herein;

FIGS. 5A and 5B are side and close-up views of a bicycle rim having notches in accordance with one example of the principles described herein;

FIG. 6 is an overhead view illustrating a wheel in a wind tunnel and the associated free stream wind direction and drag components;

FIGS. 7A, 7B and 7C are graphs showing wind tunnel test results of aerodynamic drag versus yaw angle for several wheels having notched rims in accordance three examples of the principles described herein;

FIGS. 8A and 8B provide a cross sectional view of a rim having a hemispherical notch and a side view of a section of the rim in the vicinity of the notch.

FIGS. 9A and B are flowcharts depicting exemplar methods for forming carbon fiber composite rims with notches according to the principles described herein.

### DETAILED DESCRIPTION

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with that example is included as described, but may not be included in other examples.

In the present specification and in the appended claims, the term “pre-preg” is meant to be understood as plies of pre-impregnated composite fibers where a matrix material, such as epoxy, has impregnated the composite fibers.

Additionally, in the present specification and in the appended claims, the term “tow-preg” is meant to be understood as strands of pre-impregnated composite strands where a matrix, such as epoxy, has impregnated the composite strands.

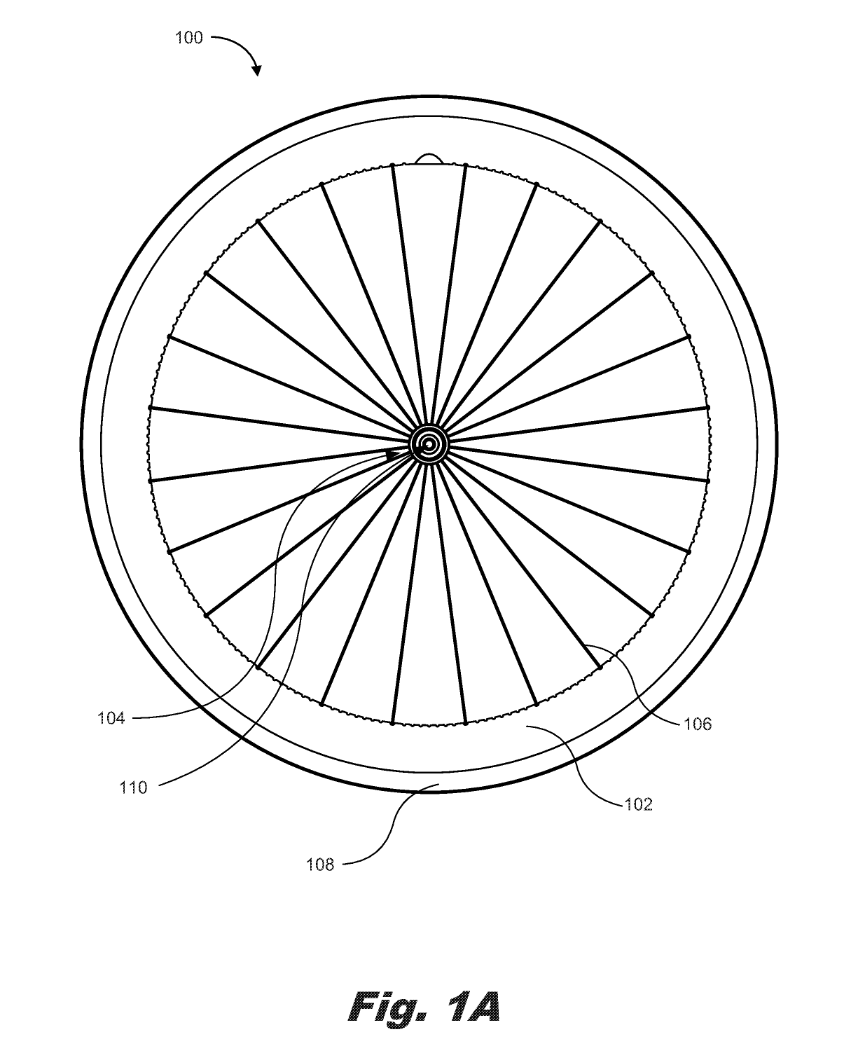

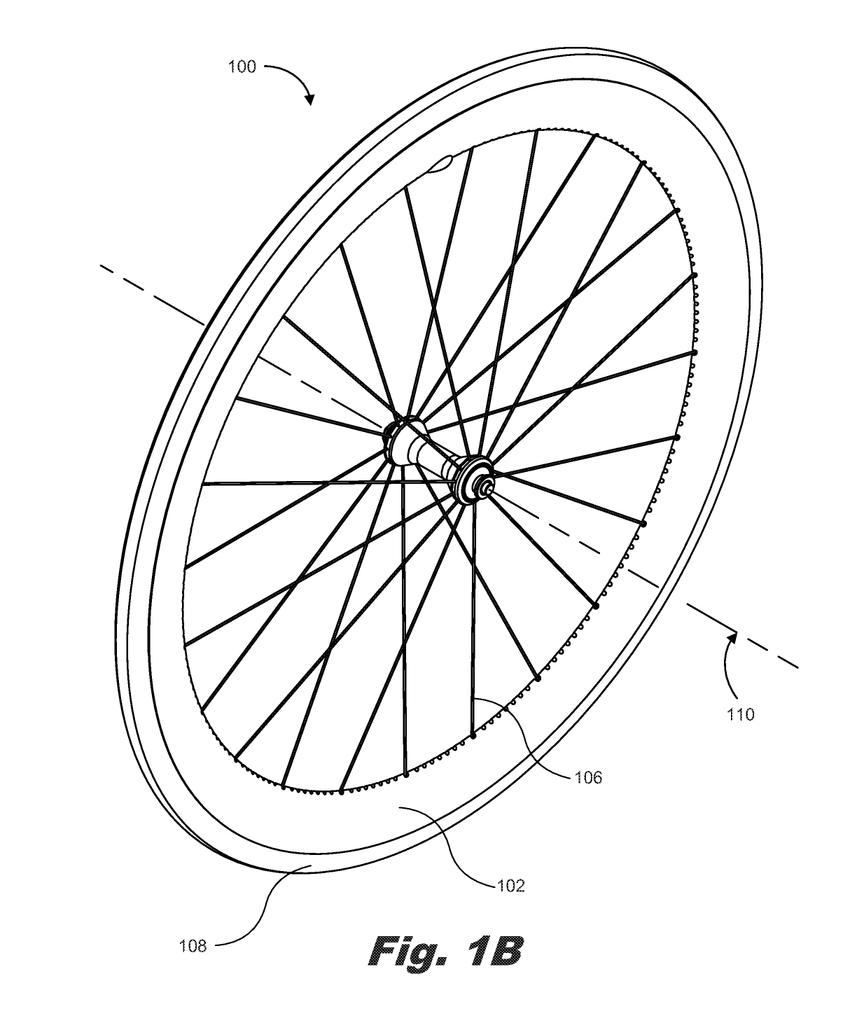

Referring to FIGS. 1A and 1B, a bicycle wheel (100) is illustrated. The bicycle wheel (100) includes a rim (102), a hub (104) and a plurality of spokes (106). The plurality of spokes (106) connect the rim (102) to the hub (104) in radial manner. A tire (108) is secured to the outer surface of the rim (102), which includes tubular, clincher and tubeless configurations, all of which are applicable to the discussion herein. Similarly, various hub and spoke configurations are contemplated, the precise construction of which may vary based on the concepts discussed herein or additional factors. In an example, alloy or carbon fiber spokes may be used. In general, the rim (102) is an annular member designed for rotation about a central axis (110). In some examples set forth herein, the rim may be constructed of carbon fiber composite materials, but other materials—e.g., aluminum or metal alloys—are contemplated as well.

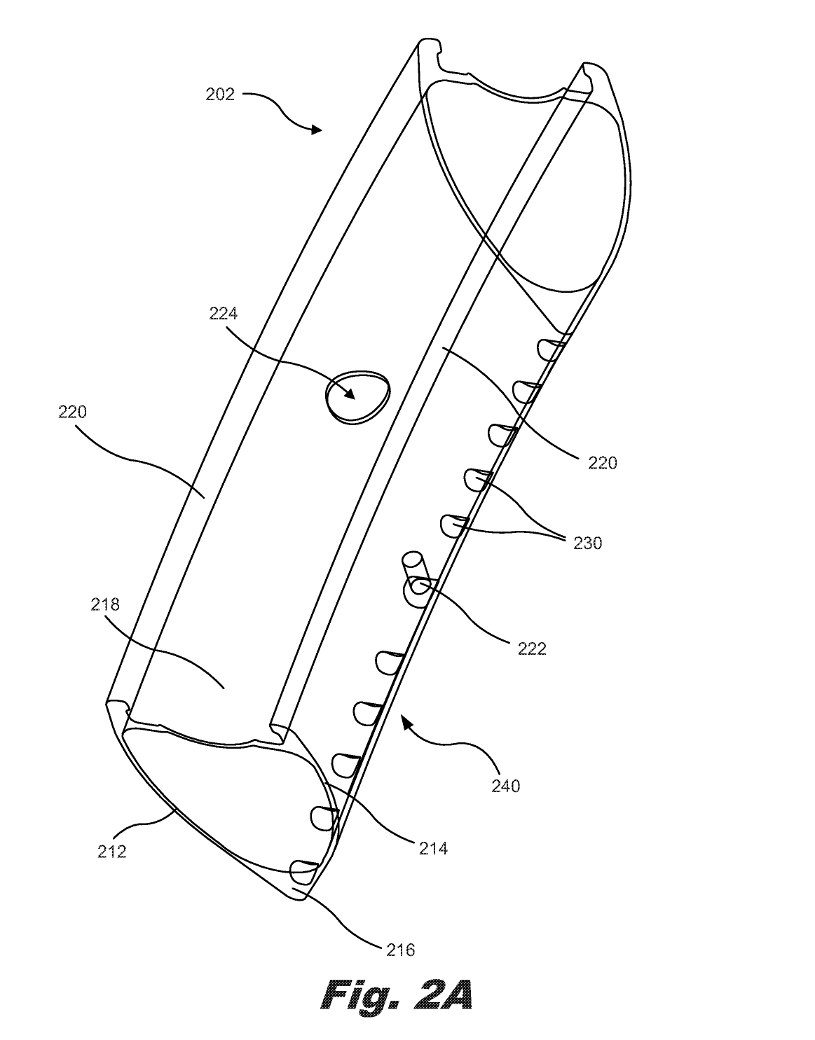

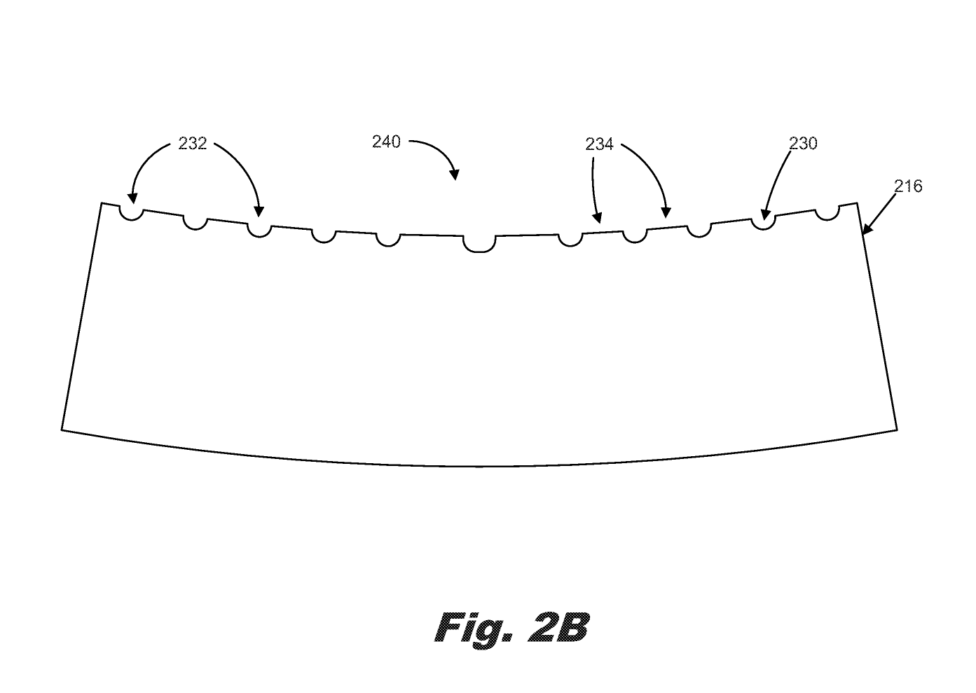

Referring now to FIGS. 2A and 2B, shape design of a rim in accord with the principles disclosed herein is discussed. In FIG. 2A, a section of a rim (202) is illustrated. The rim (202) is substantially circular (see FIGS. 1A and B), and includes a first annular side wall portion (212) and a second annular sidewall portion (214). The first annular side wall portion (212) and the second annular sidewall portion (214) are connected at inner circumferential ends to form an inner annular portion (216). The outer circumferential ends of the first annular side wall portion (212) and the second annular sidewall portion (214) are connected together by an outer annular portion (218). The outer annular portion (218) may receive and engage a tire thereon (see FIGS. 1A and B). A clincher configuration is illustrated in FIG. 2A for securing the tire to the rim. The clincher configuration includes a pair of hook members (220) extending radially outwardly from the first (212) and second (214) annular sidewall portions. The pair of hook members (220) receive and secure bead portions of a tire. While the disclosure herein focuses on clincher configurations, those skilled in the art will appreciate the same principles described herein apply equally to tubular and tubeless rim configurations.

Still referring to FIGS. 2A and 2B, the first annular side wall portion (212) and the second annular sidewall portion (214) define a single-piece, unitary body of the rim (202). In an example, the body of the rim (202) may be hollow, as illustrated, but solid or filled-in constructions are contemplated by the present disclosure. The inner annular portion (216) has a plurality of spoke attachment openings (222) for receiving and attaching first ends of the plurality of spokes to the rim (202). Similarly, the outer annular portion (218) has a plurality of spoke access openings (224) for accessing second ends of the spokes and, in particular, to access nipples (not shown) used to secure spokes to attachment regions (or built up sections) near or as part of the inner annular portion (216) of the rim (202).

Referring now to FIG. 2B, a close up of a section of the inner annular portion (216) of the rim (202) is shown illustrated. The inner annular portion (216) of the rim (202) has a plurality of notches (230) spaced along the inner circumference or the radially inward-most surface (240) of the inner annular portion (216) of the rim. To clarify, in this disclosure, the inner circumference and the radially inward-most surface of the rim refer to the same portion of the rim, which is generally the inward portion of the rim where notches are positioned, either by cutting into the rim material beneath the surface or by fastening or otherwise positioning notches on the rim surface. Cutting or otherwise positioning notches on both symmetric and asymmetric rim profiles is contemplated in this disclosure. In one example, the notches (230) are defined by a series of depressions (232) spaced along the inner circumference or the radially inward-most surface (240) of the inner annular portion (216) of the rim. Adjacent each depression (232) are edge sections (234). The combination of depressions (232) and edge sections (234) create an uneven or serrated-like edge surface along the inner circumference or the radially inward-most surface (240) of the inner annular portion (216) of the rim.

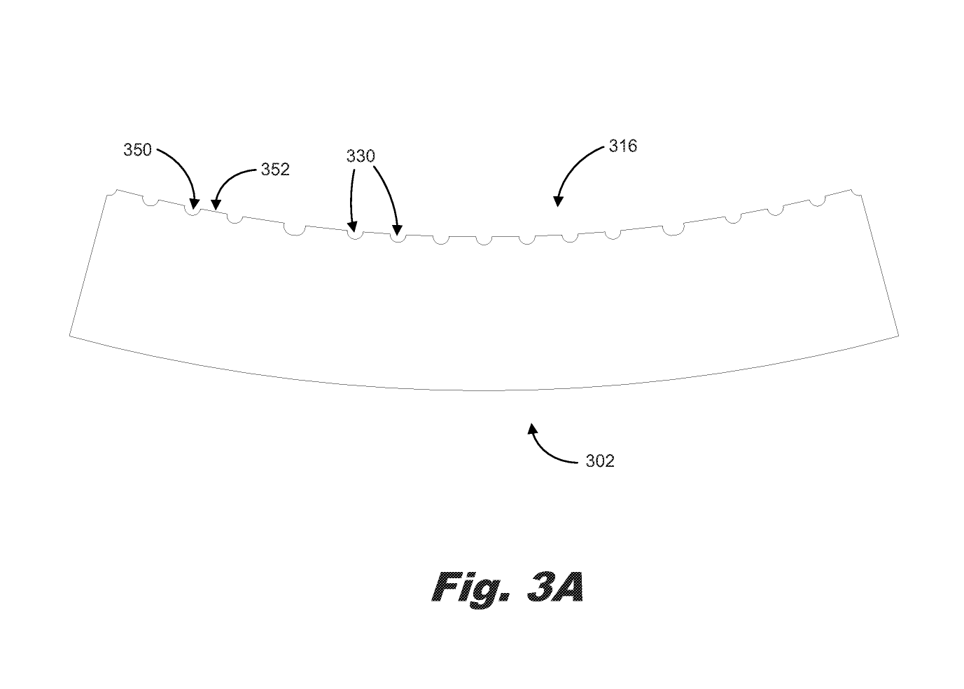

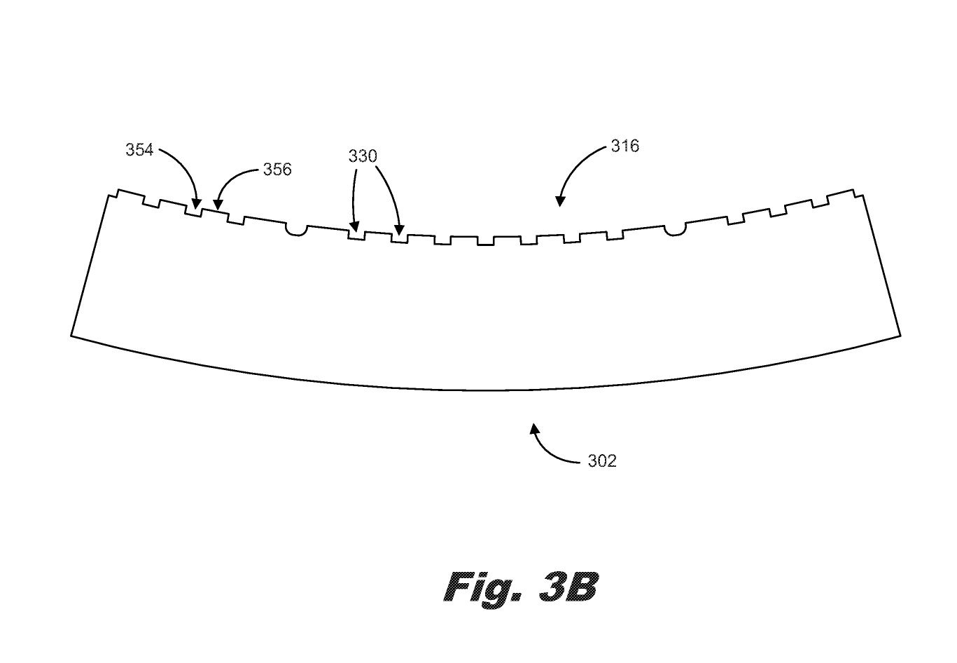

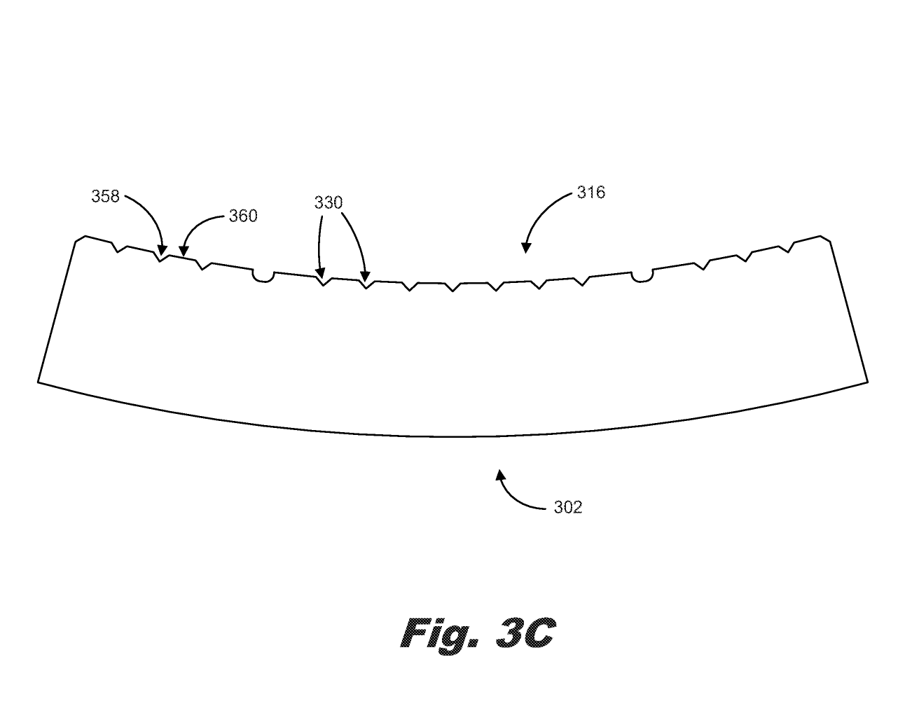

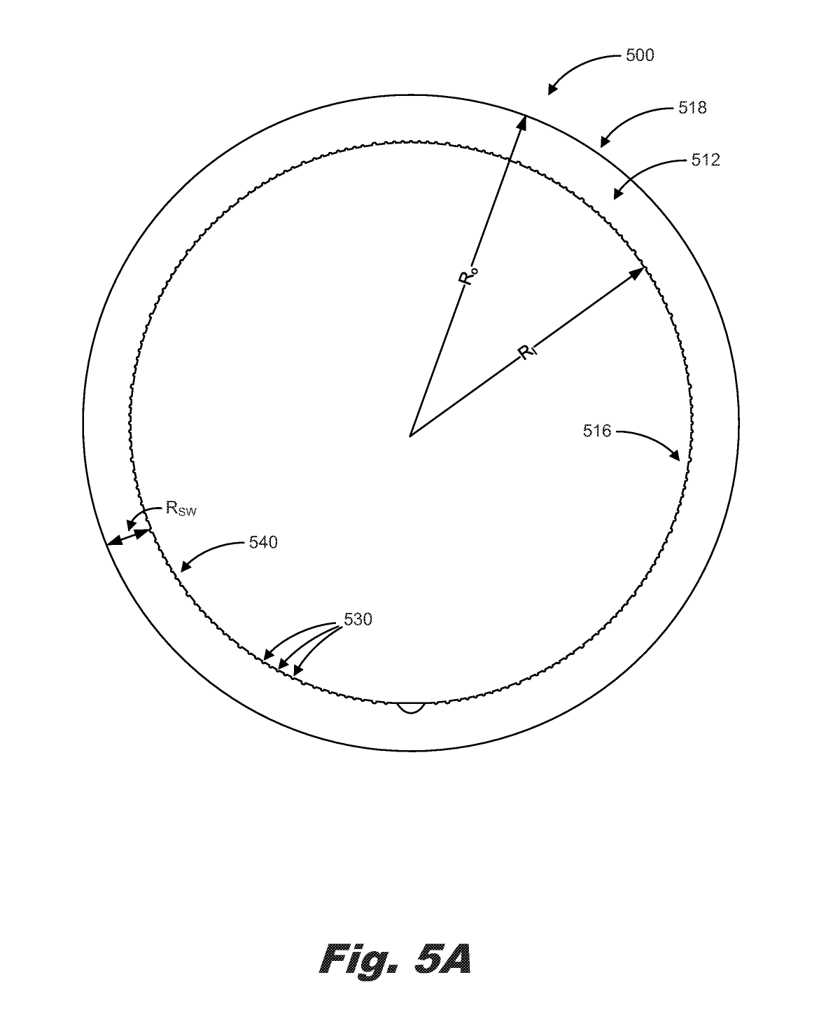

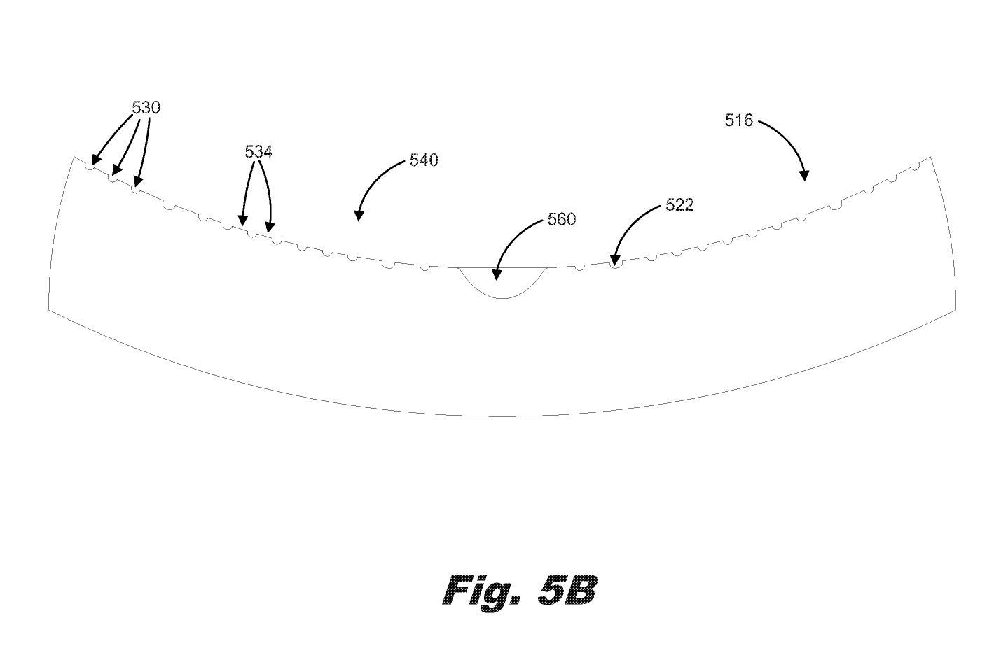

Referring now to FIGS. 3A, 3B and 3C, further close up sections of an inner annular portion (316) of a rim (302) are illustrated, providing additional exemplar details concerning the structure of notches (330) located along an inner circumference or radially inward-most surface (340) of the rim. For example, a plurality of notches (330) is illustrated on the inner circumference or the radially inward-most surface (340) of the inner annular portion (316) of the rim. In FIG. 3A, the notches (330) are hemispherical notches (350) that are hemispherical in cross section and separated by edge sections (352). In FIG. 3B, the notches (330) are square notches (354) that are square in cross section and separated by edge sections (356). In FIG. 5C, the notches (330) are triangular notches (358) triangular in cross section and separated by edge sections (360).

In general, the sides of a notch intersect the edge sections at a sharp, defined angle, as opposed to a smooth or undulating transition. For example, the sides of the square notches (354) in FIG. 3B intersect the connecting edges (356) at about 90 degree angles; trapezoidal shaped notches, however, will have different angles where the sides of the trapezoid intersect the edges depending on the shape of the trapezoidal cross section. Similarly, the sides of the hemispherical notches (350) in FIG. 3A will also meet the connecting edges (352) at about 90 degrees; however, it is contemplated that examples employing less than full hemispherical cross sections will intersect the edges at angles greater than 90 degrees. For the triangular notches (358) in FIG. 3C, the angle between the sides of the notch and the connecting edges (360) will depend on the cross sectional geometry of the triangle. For example, for an equilateral triangle, the angle between the sides of the notch (358) and the edges (360) will be about 120 degrees. Similarly, for varying geometries of notches (358) having cross sections of isosceles triangular shapes, the intersecting angles will vary between extremes of about 180 degrees for very flat triangles and 90 degrees for very sharp triangles. For triangular cross sections other than equilateral or isosceles, the intersecting angles on each side of the notch will be different, depending on the shape of the triangular notch (358). While various cross sectional shapes of notches have been described, it is contemplated that a combination of different shaped and sized notches may be included in a rim.

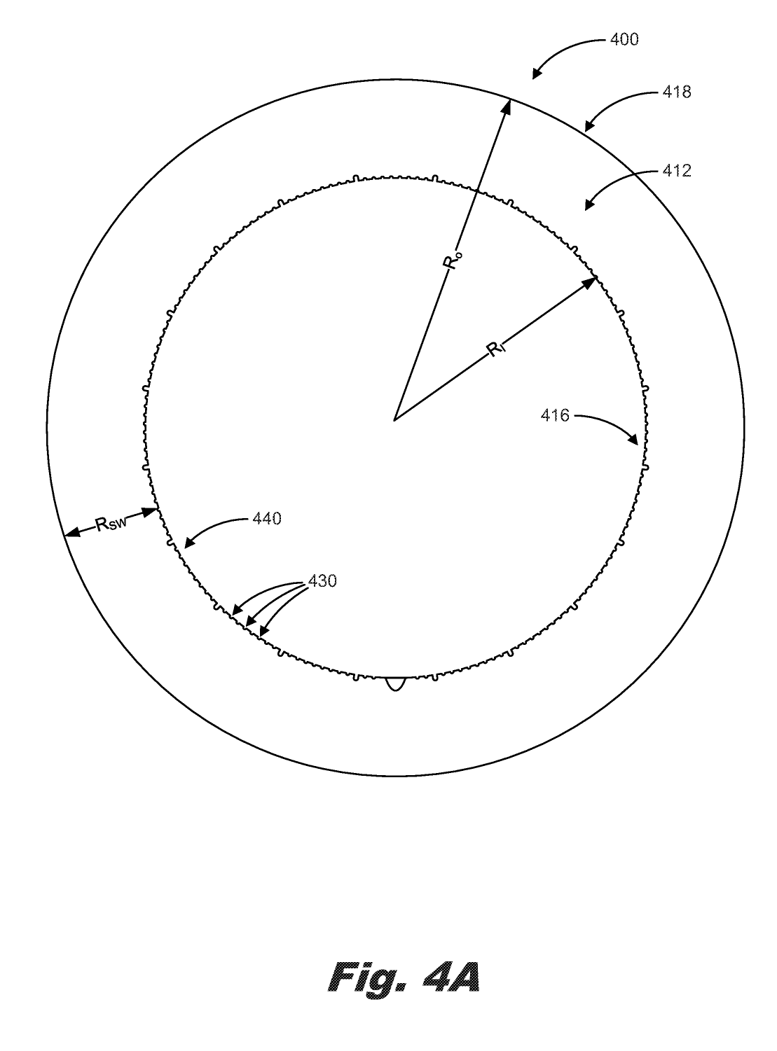

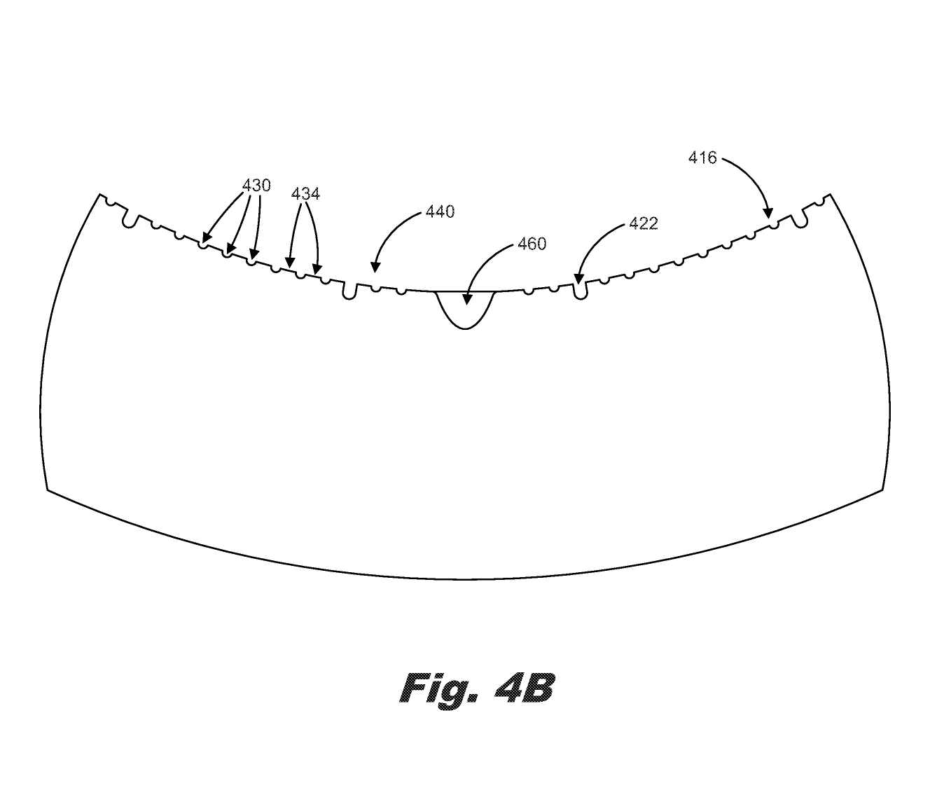

In general, the spacing of notches on the inner circumference of a rim is arbitrary, but a sufficient number of properly sized notches and connecting edges may be positioned to gain the beneficial aerodynamic effect obtained by disturbing the airflow at the inner circumference or radially inward-most surface of the inner annular portion of a rim. Referring, for example, to FIGS. 4A and 4B, an exemplar rim having notches is shown in cross section with the indicated portion blown up. In FIGS. 4A and 4B, a rim (400) is illustrated having an inner annular portion (416) and an outer annular portion (418). A first annular sidewall portion (412) extends between the inner and outer annular portions. A second annular sidewall portion is positioned opposite the first annular sidewall portion (412) but is hidden from view. The rim (400) includes a plurality of notches (430) located along the inner circumference or the radially inward-most surface (440) of the inner annular portion (416) of the rim. Exemplar dimensions for the rim (400) are approximately 316 mm in radius (Ro) for the outer annular portion (418) and approximately 226 mm in radius (Ri) for the inner annular portion (416). The first and second annular sidewall portions are approximately 90 mm in radial dimension (Rsw), extending between the inner and outer annular sidewall portions as described above. Referring specifically to FIG. 4B, there is shown spoke hole attachment openings (422) and a tire valve access opening (460). Positioned between the spoke hole attachment openings is a plurality of notches (430).

In one example, the notches (430) are hemispherical with a cross sectional radius from about 1 mm to about 3 mm. Positioned between each pair of notches (430) is an edge section (434). In one example, the edge sections (434) extend from about 2 mm to about 6 mm along the inner circumference or the radially inward-most surface (440) of the inner annular portion (416) of the rim, with the longer edge sections (434) corresponding to the notches (430) having smaller radius and the shorter edge sections (434) corresponding to the notches (430) having larger radius. In one example, the notches are hemispherical with a cross sectional radius about 1.5 mm and edge section lengths about 5 mm. This configuration results in approximately 160 notches for the rim above described with reference to FIGS. 4A and 4B (or 10 notches (430) between adjacent spoke hole attachment openings (422)). For the same spacing and size of notches, rims having a relatively greater value for the radius (Ri) for the inner annular portion (416) will have a proportionately greater number of notches and, similarly, rims having a relatively lesser value for the radius (Ri) for the inner annular portion (416) will have a proportionately lesser number of notches.

Referring to FIGS. 5A and 5B, for example, a rim (500) is illustrated having an inner annular portion (516) and an outer annular portion (518). A first annular sidewall portion (512) extends between the inner and outer annular portions. A second annular sidewall portion is positioned opposite the first annular sidewall portion (512) but is hidden from view. The rim (500) includes a plurality of notches (530) located along the inner circumference or the radially inward-most surface (540) of the inner annular portion (516) of the rim. Exemplar dimensions for the rim (500) are approximately 316 mm in radius (Ro) for the outer annular portion (518) and approximately 270 mm in radius (Ri) for the inner annular portion (516). The first and second annular sidewall portions are approximately 46 mm in radial dimension (Rsw), extending between the inner and outer annular sidewall portions as described above. Referring specifically to FIG. 5B, there is shown spoke hole attachment openings (522) and a tire valve access opening (560). Positioned between the spoke hole attachment openings is a plurality of notches (530) and connecting edges (534). In an example similar to the one described above, the notches are hemispherical with a cross sectional radius about 1.5 mm and edge section lengths about 5 mm. This configuration results in approximately 194 notches for the rim above described with reference to FIGS. 5A and 5B (or 12 notches (530) between adjacent spoke hole attachment openings (522)).

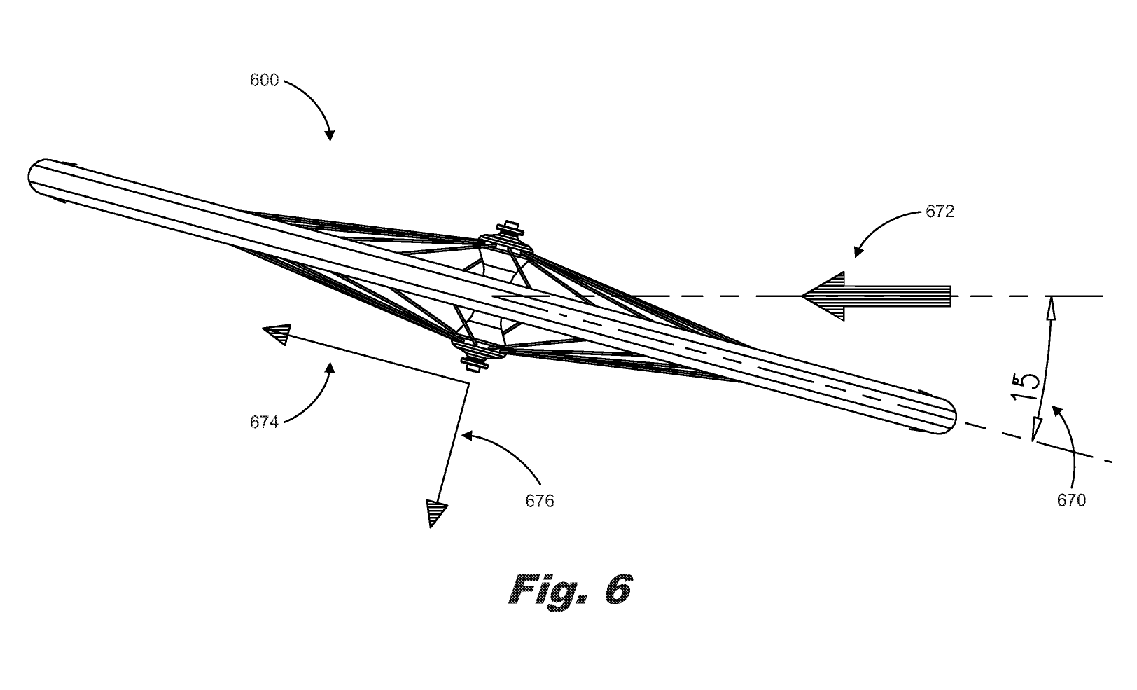

Wind tunnel testing was carried out on three wheel sets having notched and un-notched configurations. Specifically, rims from the REYNOLDS® Cycling Aero product line having annular sidewall portion dimensions (Rsw) of approximately 46 mm, 72 mm and 90 mm were used to test the effect of notches on aerodynamic drag versus yaw angle for rims having notches positioned along the inner circumference or the radially inward-most surface of the inner annular portion of the rim. Referring to FIG. 6, a top-view schematic of the test setup is illustrated. A wheel (600) with tire is positioned in a wind tunnel. The wheel (600) is positioned at a yaw angle (670) with respect to a free stream flow of wind (672) developed by the wind tunnel. The wheel rotates about its hub at an angular velocity equal to a hypothetical translational velocity. The aerodynamic forces on the rotating wheel (600) in the presence of the free stream flow of wind (672) produce an axial drag (674) (in a direction opposite the direction of hypothetical translation) and a side force (676).

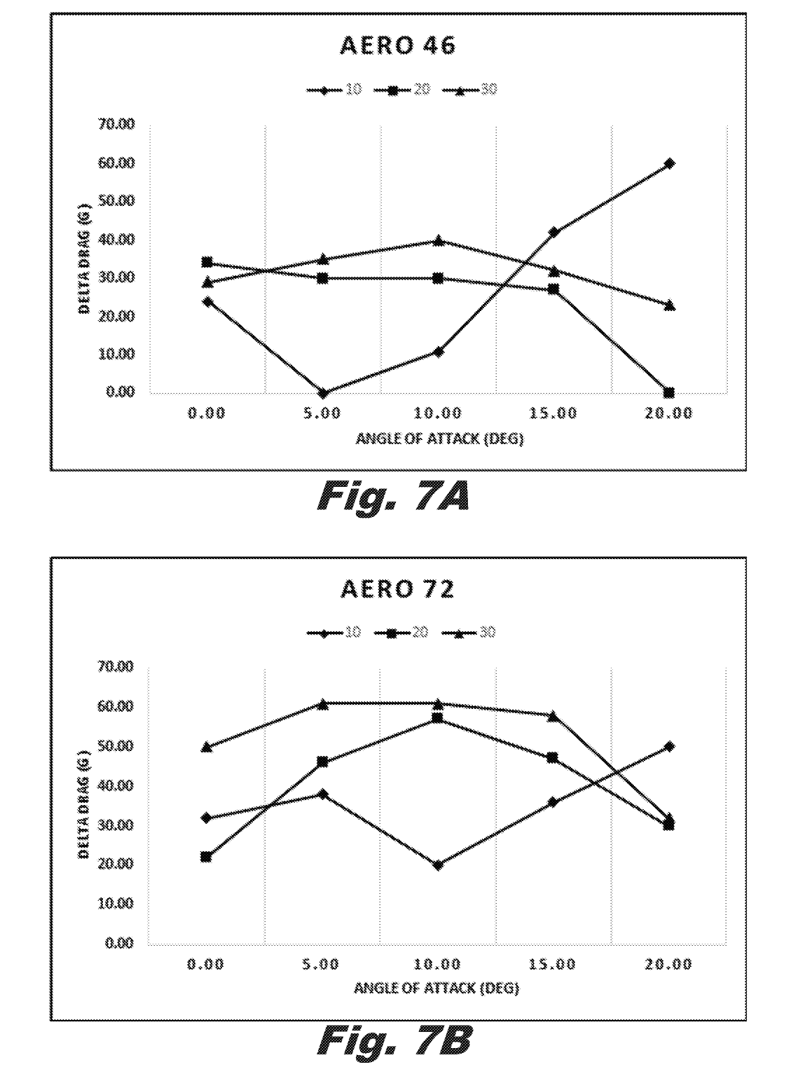

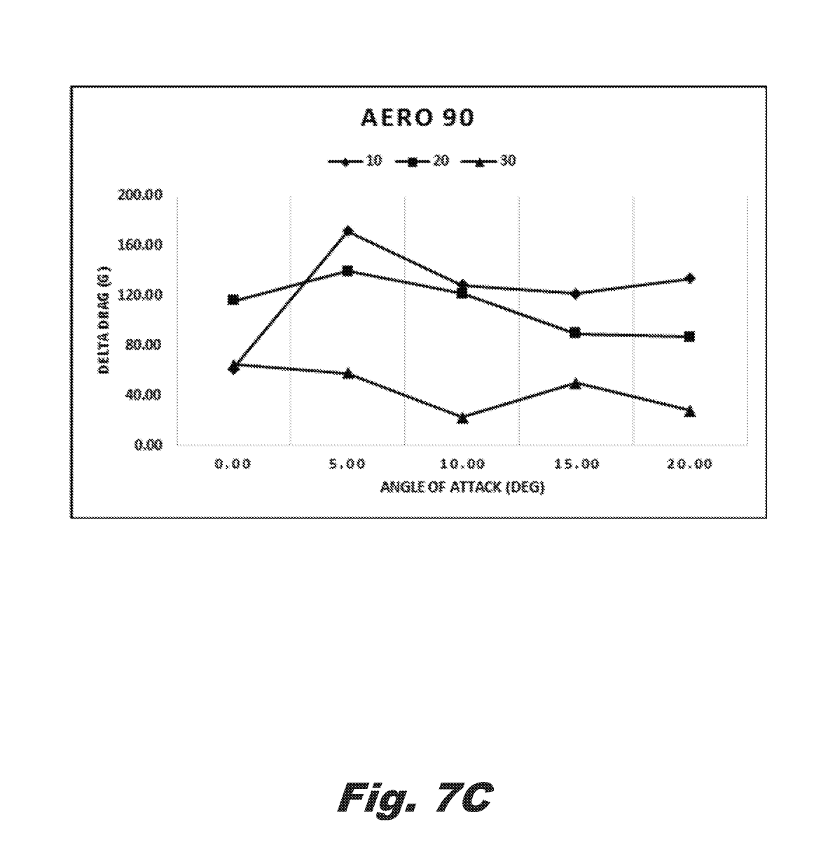

The notch configuration in each rim being tested is hemispherical with radius equal to about 1.5 mm. The spacing between notches is about 5 mm for each of the 46 mm, 72 mm and 90 mm rims. The wind tunnel testing shows that, at yaw angles of 0, 5, 10, 15 and 20 degrees, the drag force in the axial direction is reduced, generally substantially. Results of the testing are presented in FIGS. 7A, 7B and 7C. In all cases, the rotational velocity of the wheel is set at about 32 rad/sec (equating to a translational velocity of about 40 kph). Tests for each set of wheels (notched and un-notched) were conducted at free stream wind velocities of 10, 20 and 30 kph over the range of yaw angles between 0 and 20 degrees.

Referring to FIG. 7A, for example, drag results for the AERO 46 are presented. The horizontal axis records the yaw angle (or angle of attack) with respect to the free stream and the vertical axis records the difference in drag between the un-notched and notched rims. The difference in drag (labeled “Delta Drag” in FIGS. 7A-C) is recorded in grams. Conversion to the more familiar term of Newtons(N) is easily obtained by multiplying the drag quantity by the appropriate constant for acceleration (e.g., 9.81 m/s²), being careful to ensure consistency of units. The three lines of data in FIG. 7A correspond to the 10, 20 and 30 kph free stream wind velocities. Notably, with the exception of two points recording near zero difference in drag, the results indicate the notches produce a substantial decrease in drag over the range of free stream velocities and yaw angles. Similar trends are indicated by the results for the AERO 72 mm and 90 mm rims shown in FIGS. 7B and 7C, respectively.

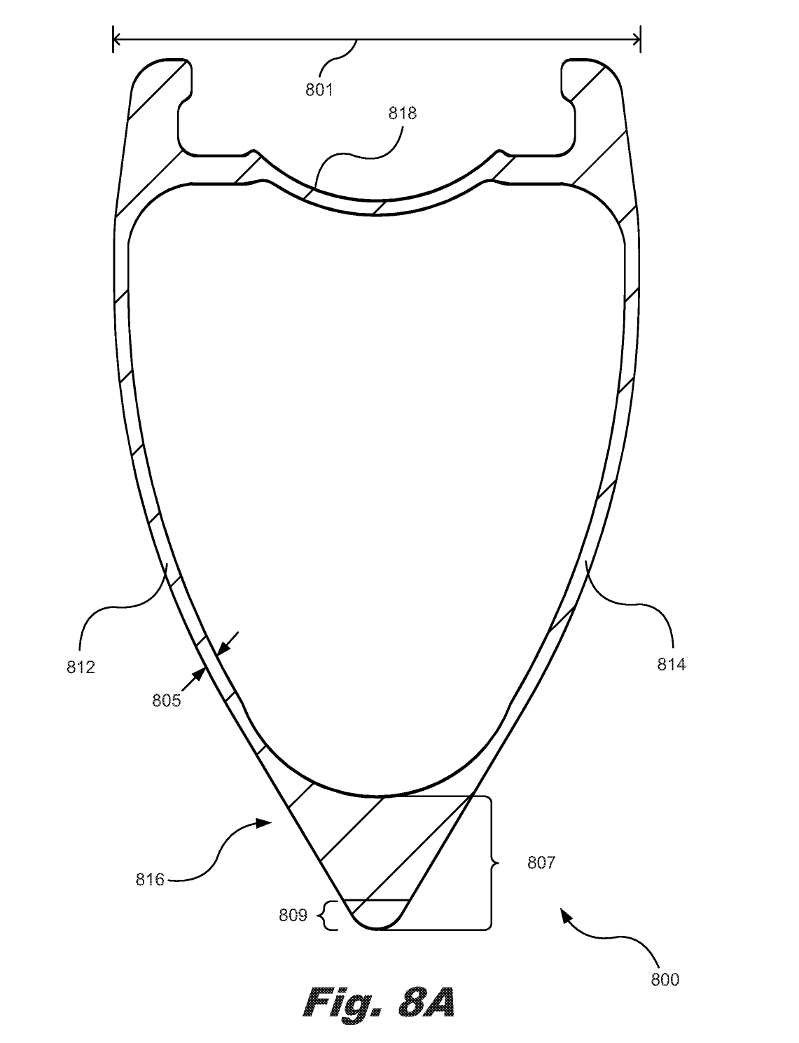

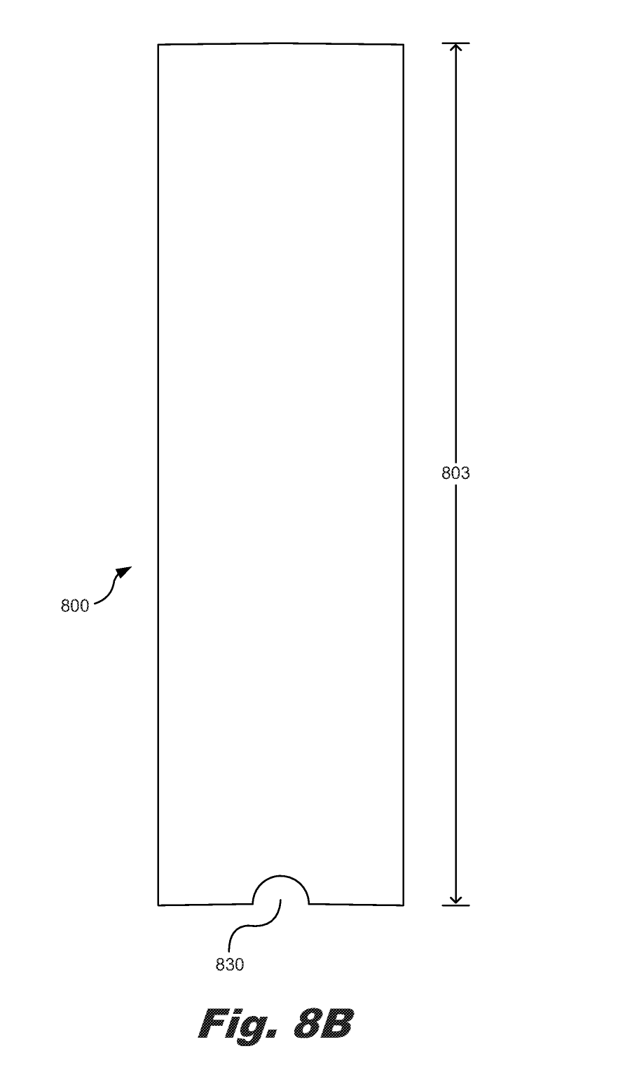

In one example, a notched rim is constructed using carbon fiber composite materials. Rims according to the principles described herein may be constructed using techniques disclosed in co-pending U.S. patent application Ser. No. 14/226,647, entitled “Bicycle Wheels with Asymmetric Carbon Fiber Rims,” the entirety of which is incorporated by reference. Illustrated in FIGS. 8A and 8B is a cross sectional view of a rim (800) having a hemispherical notch (830) and a side view of a section of the rim in the vicinity of the notch, respectively. The rim (800) is constructed of carbon fiber composite materials using techniques such as those disclosed in Ser. No. 14/226,647. Note the rim (800) depicted in FIGS. 8A and 8B is not drawn to scale and the thickness of the various elements have been exaggerated for purposes of illustration.

In some examples, the widest portion (801) of the rim (800) may be about 24 mm to about 28 mm and the height (803) of the rim (800) may be about 40 mm to 100 mm. As described above, the rim (800) generally includes a first annular sidewall portion (812) and a second annular sidewall portion (814). The first annular side wall portion (812) and the second annular sidewall portion (814) are connected at inner circumferential ends to form an inner annular portion (816). The outer circumferential ends of the first annular sidewall portion (812) and the second annular sidewall portion (814) are connected together by an outer annular portion (818). The outer annular sidewall portion (818) is sized to receive and engage a tire (not illustrated). The first (812) and second (814) annular sidewall portions have a thickness (805) that may be about 0.5 mm to about 3 mm and may vary along the length of the sidewall. The inner annular portion has a depth (807) and the hemispherical notch (830) has a radius; notches having other shapes—e.g., square or triangular—have similar characteristic dimensions, other than a radius, such as the length of a side of the square or the base or height of the triangle. The depth (807) of the inner annular portion (816) is sized to provide strength along the inner circumference of the rim when notches are cut into the inner annular portion (816). In one example, the depth (807) is about twice the radius (809) of the notch for a hemispherical notch. For rims constructed using carbon fiber composites, the depth can be constructed using plies of pre-preg or tow-preg or, a combination of the two.

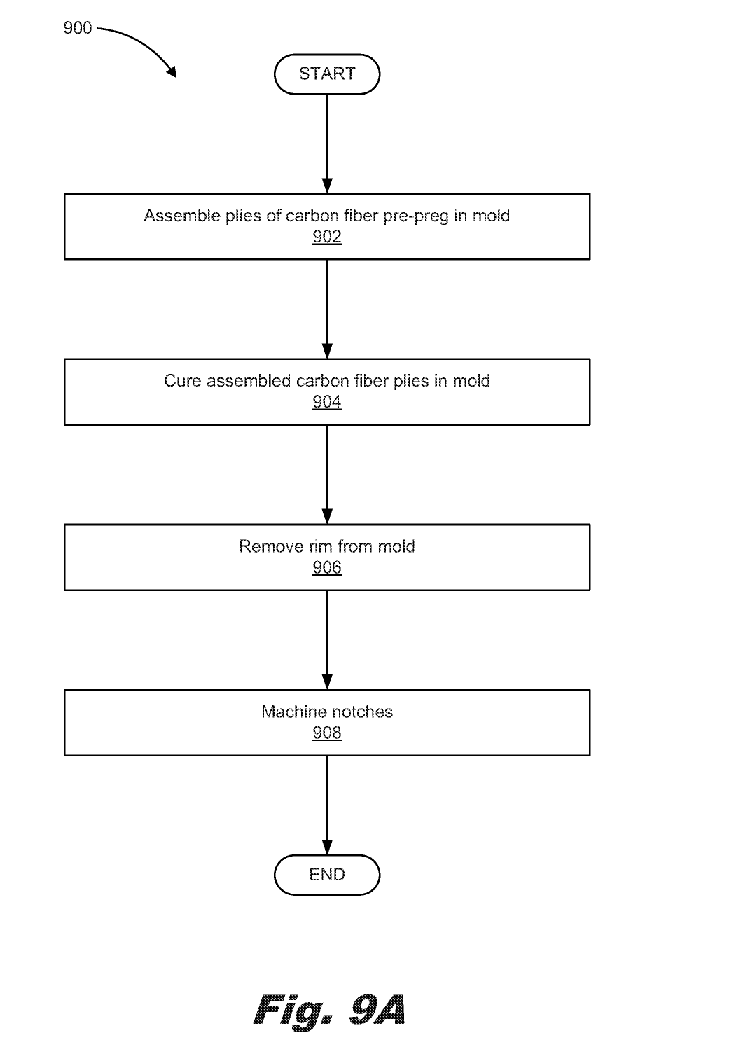

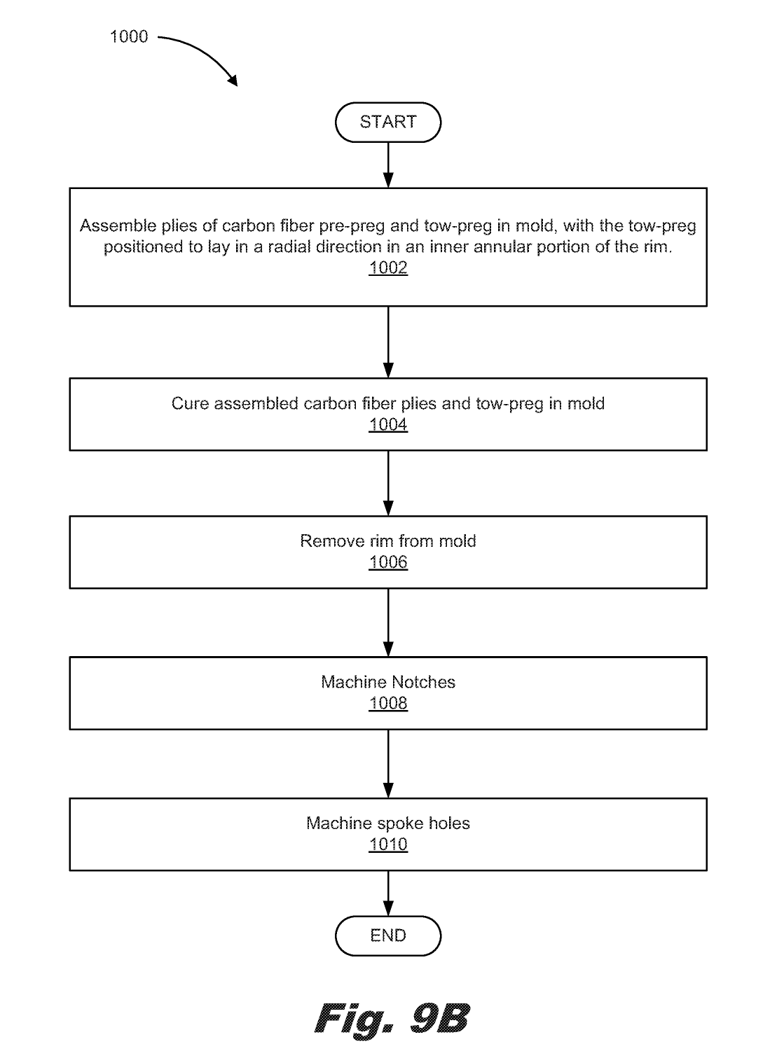

Referring to FIG. 9A, an example of a process (900) for manufacturing a carbon fiber composite-based rim having notches is described. The process may begin with plies of carbon fiber pre-preg being assembled (902) in a rim mold. In one example, assembling (902) of the plies of carbon fiber may include the techniques disclosed in U.S. application Ser. No. 14/226,647. The process may continue with the assembled carbon fiber plies being cured (904) in the mold. The cured rim may be removed (906) from the mold. In one example, the cured rim may be subjected to a post-curing process. The post-curing processes may be conducted based on the type and characteristics of the plies of carbon fiber pre-preg assembled within the rim mold.

The process may continue with the cured rim being affixed to a machining device, such as a computer numerically controlled (CNC) drilling machine where notches—e.g., hemispherical, triangular or rectangular notches—are machined (908), e.g., drilled, in a pre-determined pattern around the inner circumference of the rim. In an example, other features of the rim, such as spoke attachment openings and access openings, may also be machined, e.g., drilled, in the rim.

Referring to FIG. 9B, a second example of a process (1000) for manufacturing a carbon fiber composite-based rim having notches is described. The process (1000) may begin with assembling (1002) plies of carbon fiber pre-preg and tow-preg in a rim mold using. In an example, this may be done using the techniques disclosed in U.S. application Ser. No. 14/226,647. In an example, the tow-preg is positioned during the assembly process to lay in a radial direction in the inner annular portion of the rim. The process (1000) may continue with the assembled carbon fiber plies and tow-preg being cured (1004) in the mold. The process (1000) may continue with the cured rim being removed (1006) from the mold. The process (1000) may continue with the cured rim being affixed to a machining device, such as a computer numerically controlled (CNC) drilling machine, and notches—e.g., hemispherical, triangular or rectangular notches—being machined (1008), e.g., drilled, in a pre-determined pattern around the inner circumference of the rim. Other features of the rim, such as spoke attachment openings and access openings, are machined (1010), e.g., drilled, in the rim.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A bicycle rim, comprising:
a rim body having an inner annular portion and an outer annular portion spaced radially outward from the inner annular portion, the inner annular portion having a circumference defined by the radially inward-most surface of the inner annular portion; and
a plurality of notches spaced circumferentially along the circumference, the notches recessed within the inner annular portion to form a serrated edge along the circumference.

2. The bicycle rim of claim 1, wherein the serrated edge is formed using a plurality of hemispherical shaped notches separated by edges.

3. The bicycle rim of claim 2, wherein the hemispherical shaped notches and edges intersect at an angle of about ninety degrees.

4. The bicycle rim of claim 2, wherein the rim body includes a plurality of spoke attachment openings and wherein the hemispherical shaped notches are evenly spaced between adjacent spoke attachment openings.

5. The bicycle rim of claim 3, wherein the hemispherical shaped notches are positioned within the inner annular portion of the rim body.

6. The bicycle rim of claim 5, wherein the rim body is constructed using a carbon fiber based material.

7. The bicycle rim of claim 6, wherein the outer annular portion comprises a pair of opposed circumferential hook members to receive and engage a tire.

8. A bicycle rim, comprising:
a rim body having first and second opposing annular sidewall portions, an outer annular portion connecting outer circumferential portions of the first and second annular sidewall portions and an inner annular portion connecting inner circumferential portions of the first and second annular sidewall portions;
a plurality of notches spaced circumferentially along the circumference, the notches recessed within the inner annular portion to form a serrated edge along the circumference.

9. The bicycle rim of claim 8, wherein the serrated edge is formed using a plurality of hemispherical shaped notches separated by edges.

10. The bicycle rim of claim 9, wherein the hemispherical shaped notches include side portions that intersect the edges at angles of about ninety degrees.

11. The bicycle rim of claim 10, wherein the hemispherical shaped notches have a radius of about 1.5 mm and the edges have a length of about 5 mm.

12. A method of making a rim having a number of notches, comprising:
assembling carbon fiber plies of pre-preg in a mold shaped for a bicycle rim;
curing the assembled plies in the mold;
removing the rim body from the mold; and
machining the plurality of notches spaced circumferentially along the radially inward-most surface of the inner annular portion of the rim body, the notches recessed within the inner annular portion to form a serrated edge along the circumference.

13. The method of claim 12, wherein the notches are machined using a computer numerically controlled drilling machine.

14. The method of claim 12, wherein the serrated edge is formed by machining a plurality of hemispherical shaped notches separated by edges.

15. The method of claim 13, wherein the hemispherical shaped notches are machined to include side portions that intersect the edges at angles of about 90 degrees.

16. The method of claim 12, wherein the serrated edge is formed by machining a plurality of triangular shaped notches separated by edges.

17. The method of claim 12, wherein the serrated edge is formed by machining a plurality of rectangular shaped notches separated by edges.

18. The method of claim 15, further including the step of machining a plurality of spoke attachment openings.

19. The method of claim 12, wherein the assembling step further includes assembling tow-preg in the mold shaped for a bicycle rim.

20. The method of claim 19, wherein the assembling step further includes laying the tow-preg in a radial direction in the inner annular portion.
